(19) United States
(12) Patent Application Publication
(10) Pub. No.: US 2013/0130660 A1
(43) Pub. Date: May 23, 2013

(54) AUTOMATED DIARY LOGGING OF EVENTS RELATING TO WIRELESS MOBILE COMMUNICATION DEVICE

(71) Applicants: Rita Sadhvani, Watchung, NJ (US); Hannah Youngsil Moon, Boston, MA (US)

(72) Inventors: Rita Sadhvani, Watchung, NJ (US); Hannah Youngsil Moon, Boston, MA (US)

(73) Assignee: Cellco Partnership d/b/a Verizon Wireless, Basking Ridge, NJ (US)

(21) Appl. No.: 13/363,101

(22) Filed: Jan. 31, 2012

Related U.S. Application Data
(63) Continuation-in-part of application No. 13/302,431, filed on Nov. 22, 2011.

(51) Int. Cl. H04W 4/02

(52) U.S. Cl. 455/414.1

(57) ABSTRACT

A wireless mobile communication device may be configured to automatically cause event information indicative of events related to the wireless mobile communication device to be entered into a diary in association with date information indicative of when each event took place. The events may include changes in location; communications such as phone calls, text messages, instant messages, and emails; the capturing of images; and/or calendared events. The location at which each communication, capture of images, and/or calendared event has taken place may also be automatically entered into the diary, along with the event information.

### CROSS-REFERENCE TO RELATED APPLICATIONS

This is a continuation-in-part of U.S. patent application Ser. No. 13/302,431, entitled “Updating Social Networks In Response To Trigger Events On Mobile Communication Device,” filed Nov. 22, 2011, Attorney Docket No. 20110886 (50108-0618), the entire content of which is incorporated herein by reference.

### BACKGROUND

1. Technical Field

This disclosure relates to wireless mobile communication devices and to diaries.

2. Description of Related Art

Diaries of one's daily activities can be of great value. However, they can also be time consuming and inconvenient to generate. Also, the importance of some events may not be realized until long after they occur. This can lead to information about these events never being placed in the diary.

A software application for the Macintosh™ computer called Chronories™ has recently been introduced. This application automatically logs certain activity relating to the Macintosh™ into a diary. However, the types of activities that are logged are limited, resulting in a diary that may be missing important entries.

It is thus desirable to generate a more comprehensive diary that requires little effort and time.

### BRIEF DESCRIPTION OF DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 illustrates an example of a wireless mobile communication device configured to automatically log events relating to the wireless mobile communication device into a diary contained within the wireless mobile communication device.

FIG. 2 illustrates an example of a wireless mobile communication device configured to automatically log events relating to the wireless mobile communication device into an Internet-based diary not contained within the wireless mobile communication device.

FIGS. 3A-3E illustrate an example of a series of dialogue boxes that may be displayed on the wireless mobile communication device when setting up a diary application that logs events relating to the wireless mobile communication device into the Internet-based diary.

FIG. 3A illustrates an example of a login setup dialog box for setting up a login into the Internet-based data storage module.

FIG. 3B illustrates an example of an event-setting dialog box for indicating types of events that are to be tracked in the diary.

FIG. 3C illustrates an example of a location-setting dialog box for indicating locations that are to be entered into the diary when the wireless mobile communication device is present at the locations.

FIG. 3D illustrates an example of a layout dialog box for indicating the layout of the diary.

FIG. 3E is an example of a time period dialog box for specifying when the diary is to be compiled.

FIG. 4 illustrates an example of a page in the diary being displayed.

FIG. 5 illustrates an example of a menu of options that can be displayed when using the diary application.

### DETAILED DESCRIPTION OF ILLUSTRATIVE EMBODIMENTS

Illustrative embodiments are now described. Other embodiments may be used in addition or instead. Details that may be apparent or unnecessary may be omitted to save space or for a more effective presentation. Some embodiments may be practiced with additional components or steps and/or without all of the components or steps that are described.

A wireless mobile communication device may be configured to automatically cause event information indicative of events related to the wireless mobile communication device to be entered into a diary in association with date information indicative of when each event took place. The events may include changes in location; communications such as phone calls, text messages, instant messages, and emails; the capturing of images; and/or calendared events. The location at which each communication, capture of images, and/or calendared event has taken place may also be automatically entered into the diary, along with the event information.

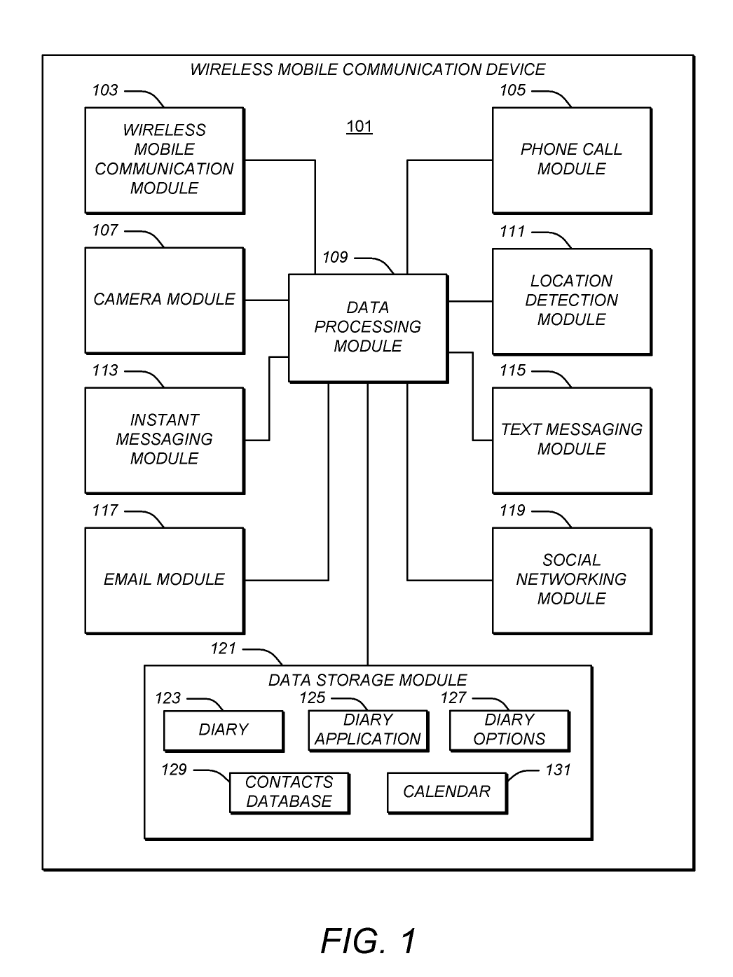

FIG. 1 illustrates an example of a wireless mobile communication device 101 that is configured to automatically log events relating to the wireless mobile communication device 101 into a diary 123 that is contained within the wireless mobile communication device 101.

The wireless mobile communication device 101 may be of any type. For example, the wireless mobile communication device 101 may be a cell phone, a smart phone, a laptop computer, a netbook, a tablet computer, or a PDA.

As illustrated in FIG. 1, the wireless mobile communication device 101 includes a wireless mobile communication module 103; a phone call module 105; a camera module 107; a data processing module 109; a location detection module 111; an instant messaging module 113; a text messaging module 115; an e-mail module 117; a social networking module 119; a data storage module 121 that contains a diary 123, a diary application 125, diary options 127, and a contacts database 129; and a calendar 131.

The wireless mobile communication module 103 is configured to wirelessly communicate with a wireless mobile communication system. The communication may be voice using a cellular communication network and/or data using a data network, such as 3G or 4G or a Wi-Fi connection to the Internet. The wireless mobile communication module 103 may include any type of electronic hardware needed to accomplish this purpose, such as a transceiver.

The phone call module 105 is configured to allow a user of the wireless mobile communication device 101 to participate in wireless phone calls using the wireless mobile communication module 103. The phone call module 105 may include any type of electronic hardware needed to accomplish this purpose, such as a microphone and loudspeaker. The phone call module 115 may also include a phone call software application.

The camera module 107 is configured to capture one or more images in the vicinity of the wireless mobile communication device 101. The camera module 107 may be configured to capture still images and/or videos. When capturing videos, the camera module 107 may include a microphone to capture sound that is also present. The camera module 107 may include a camera software application.

The location detection module 111 is configured to detect the location of the wireless mobile communication device 101. The location detection module 111 may include any type of electronic hardware needed to accomplish this purpose, such as a GPS receiver. The location detection module 111 may in addition or instead use triangulation to determine position. The location detection module 111 may be configured to translate coordinates into street addresses when determining position. To facilitate this, the location detection module 111 may include an internal database of street addresses and/or may access this information externally using the wireless mobile communication module 103. The location module may include a location software application.

The instant messaging module 113 is configured to allow a user of the wireless mobile communication device 101 to send and receive instant messages using the wireless mobile communication module 103. The instant messaging module 113 may include any type of electronic hardware needed for this purpose, such as a keyboard, pointing device, touch screen, and/or display. The instant messaging module 113 may include an instant messaging software application.

The text messaging module 115 is configured to allow a user of the wireless mobile communication device 101 to send and received text messages using the wireless mobile communication module 103. The text messaging module 115 may include any type of electronic hardware needed for this purpose, such as a keyboard, pointing device, touch screen, and/or display. The text messaging module 115 may include a text messaging software application.

The e-mail module 117 is configured to allow a user of the wireless mobile communication device 101 to send and receive e-mails using the wireless mobile communication module 103. The e-mail module 117 may include any type of electronic hardware needed for this purpose, such as a keyboard, pointing device, touch screen, and/or display. The e-mail module 117 may include an e-mail software application.

The social networking module 119 is configured to allow a user of the wireless mobile communication device 101 to post to and receive postings from one or more social networking systems, such as Facebook™, Linkedin™, and/or Twitter™. The social networking module 119 may include a social networking software application.

The data storage module 121 is configured to store various types of information, such as the diary 123, the diary application 125, the diary options 127, the contacts database 129, and the calendar 131. The data storage module 121 may include one or more computer memory devices, such as one or more RAMS, ROMs, ePROMs, flash memories, SD cards, and/or hard disk drives that may or may not be part of a single physical package. When the data storage module 121 contains multiple physical components, the diary 123, the diary application 125, the diary options 127, the contacts database 129, and the calendar 131 may be stored in the same or different physical components of the data storage module 121.

The diary 123 is data that is representative of events that have taken place relating to the wireless mobile communication device 101, in association with date information indicative of when each event took place. The data may be in any form, such as in the form of a database. The database may have various fields of information, such as a date field, a time field, a time length field, a type of event field, a description of event field, a comment field, and/or a note field. The data may also include images and/or multimedia content, such as videos and sounds, and/or links to any of this information.

The diary application 125 is a software program containing non-transitory programming instructions that are configured, when executed by the data processing module 109, to cause one or more of the various functions of the data processing module 109 that are described in this application to be performed.

The diary options 127 are various user-settable options that have been set by a user and/or by default. The diary options 127 regulate functions of the diary application 125, as described in more detail below.

The contacts database 129 is a database of contact information that may have been entered by a user of the wireless mobile communication device 101. This database may have various fields of information, such as a name field, a phone number field, an e-mail address field, an image field, and/or a street address field.

The calendar 131 contains a schedule of events, such as meetings, trips, holidays, deadlines, birthdays, and/or anniversaries. The calendar 131 may be in the form of a database that includes various fields of information, such as date, time, type of event, description, comments, and/or notes.

The data processing module 109 is configured to automatically cause event information indicative of events relating to the wireless mobile communication device 101 to be entered into the diary 123 in association with date information indicative of when each event took place. The events may be of any type. For example, the events may consist of or include the capture of images and/or sounds by the camera module 107; changes in the location of the wireless mobile communication device 101 as detected by the location detection module 111; communications with the wireless mobile communication device 101, such as phone calls that are managed by the phone call module 105, instant messages that are managed by the instant messaging module 113, text messages that are managed by the text messaging module 115, and/or e-mails that are managed by the e-mail module 117; new posts to one or more social networks that are managed by the social networking module 119; events in the calendar 131, and/or visits to websites or other network resources.

The event information that is placed in the diary 123 may include date information about when the event took place (which may be expressed in any way, such as by the date of the event, the time of the event (e.g., hour/min/sec or morning/afternoon/evening within the date), the month of the event, the season of the event, etc.), the length of the event, the location of the wireless mobile communication device 101 at the time of the event (which could be in the form of a street address or GPS coordinates), the type of event (e.g. a phone call, a photo, a video, a change in location, an instant message, a text message, an e-mail, or a social network posting), and a description of the event.

The types of event information that are placed in the diary 123 may depend upon the type of the event. For example, events that constitute communications (e.g., phone calls, instant messages, text messages, and e-mails) may include an identification of the other party to the communication, the length of the communication, and/or multimedia content that is related to the communication, such as a stored image or ring tone that is associated with the other party to the communication in the contacts database 129. Similarly, events in the calendar 131 may include the length of the event or place of the event. When the event is the capture of an image, video, and/or sound by the camera module 107, the event information may include an embedded copy of the image and/or a link to the image, video, and/or sound file. When multimedia is played during the event, the event information may include the names of the multimedia that was played.

The data processing module 109 may be configured to seek permission from a user of the wireless mobile communication device 101 before entering each instance of event information. This may be done in connection with all events or only in connection with selected types of events, dependent on the options selected by the user during setup. The data processing module 109 may be configured to allow a user to modify and/or supplement the event information that is entered in the diary 123 at the time the information is entered.

The data processing module 109 may be configured to cause the event information to be automatically entered into the diary 123 at the time of the event or at a later time. When the event information is entered into the diary 123 at a later time, the data processing module 109 may be configured to cause the event information concerning all events to be entered periodically, such as once every day, week or month, in accordance with a schedule previously set up by the user, upon request of the user (i.e., unscheduled), and/or at any other time.

The data processing module 109 may be configured to obtain information from various storage areas that contain information relating to the wireless mobile communication device 101, such as a storage area that is within the wireless mobile communication device 101 and/or outside of it, for evidence of events that are to be automatically entered into the diary 123. Such storage areas include a folder of pictures, music, and/or videos that are taken by the camera module 107, a phone call log that is maintained by the phone call module 105, a folder of instant messages managed by the instant messaging module 113, a folder or text messages managed by the text messaging module 115, a folder of e-mails managed by the e-mail module 117, and/or a folder of social networking posts managed by the social networking module 119. The data processing module 109 may be configured to perform these scans periodically, in accordance with the schedule, and/or upon user request.

The event information may be in any format. For example, it may be in the format of a table with each field of information occupying a different column. It may instead be in the form of a sentence or phrase that collectively communicates all portions of the event information.

The data processing module 109 may be configured to allow a user to display (or play in the case of sound) event information that is in the diary 123. The data processing module 109 may be configured to allow the user to specify the way in which event information is organized when displayed, such as to specify that the information be broken down by day, week, or month and/or that the information be organized based on metatags, proper nouns (e.g., location names or people names) or keywords (e.g., anniversaries, birthdays, reunions).

The data processing module 109 may be configured to allow a user to specify search criteria and to filter the event information in the diary 123 so that only event information meeting the search criteria is displayed (or played in the case of sound). The search criteria may be of any type. For example, the search criteria may consist of or include a date, a time within a particular date or range of dates, a range of dates, a range of times, a person, a location, or any logical combination of these.

The data processing module 109 may be configured to allow a user to edit the event information in the diary 123, such as to correct errors, provide comments or other elaboration, and/or to add music, graphics, and/or links.

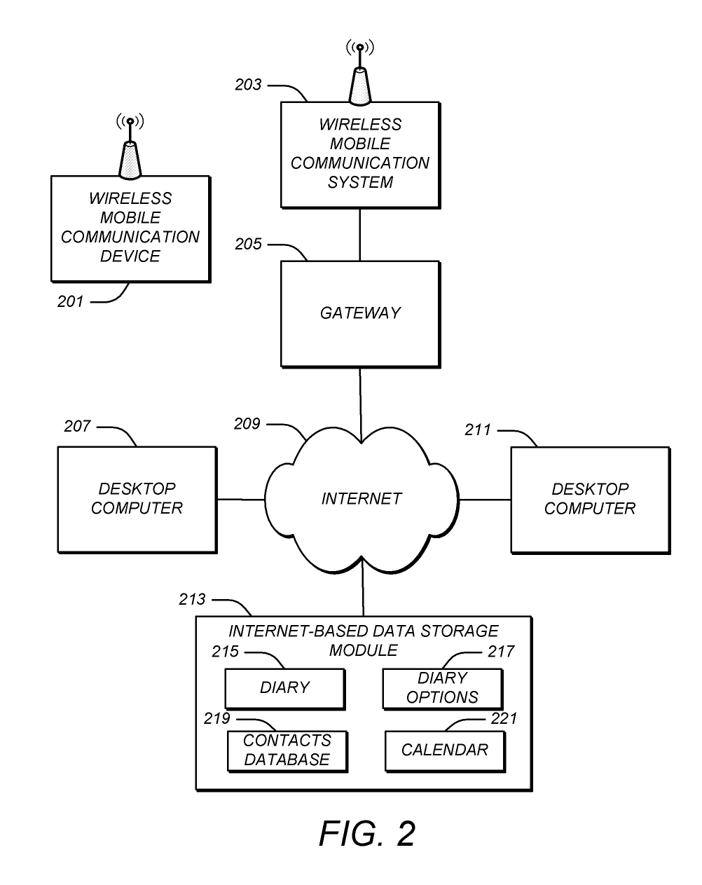

The data processing module 109 may be configured to allow a user to share all or portions of the diary 123 with others. For example, the data processing module 109 may be configured to allow a user to share all portions of the diary 123 that relate to a particular person with that particular person or venue or that relate to a particular event, such as a play, baseball game, or educational class, with all persons that are attending that event or, in some configurations, with only the persons that are attending the event that are in the contact database 129. The data processing module 109 may be configured to do so by delivering this shared information to the person or venue using the wireless mobile communication module 103. As illustrated in FIG. 2 and discussed below in more detail, the data processing module 109 may instead be configured to do so by posting all or portions of the diary 123 on a server that may be accessible to such person or venue. The data processing module 109 may be configured to impose security protections for such information, such as by requiring the particular person or venue to first authenticate themselves with a user name and password before allowing portions of the diary 123 to be displayed on the device used by the person or venue.

The data processing module 109 may be configured to allow a user to print all or selected portions of the diary 123. The printout may be bound for posterity.

FIG. 2 illustrates an example of a wireless mobile communication device 201 that is configured to automatically log events relating to the wireless mobile communication device 201 into an Internet-based diary 215 that is not contained within the wireless mobile communication device 201. The wireless mobile communication device 201 may be the same as the wireless mobile communication device 101 illustrated in FIG. 1 and discussed above, except that it may not contain the diary 123, the diary options 127, the contacts database 129, and/or the calendar 131. Instead, one or more of these may be stored in an Internet-based data storage module 213 in the form of the diary 215, diary options 217, a contacts database 219, and a calendar 221, respectively. The Internet-based data storage module 213 is configured to communicate with the Internet 209 and may be included as part of an Internet server.

In other configurations, the wireless mobile communication device 201 may also include the diary 123, the diary options 127, the contacts database 129, and/or the calendar 131. The original of these may be stored on the wireless mobile communication device 201 and a copy maintained in the Internet-based data storage module 213. Alternatively, the originals may be stored on the Internet-based data storage module 213 and a copy maintained in the wireless mobile communication device 201. In either case, the copy may be synchronized to the original, either triggered by the wireless mobile communication device 201 or the Internet-based data storage module 213.

The wireless mobile communication device 201 may be configured to communicate with a wireless mobile communication system 203 which may consist of or include a cellular communication system and/or a wireless data communication system, such as a 3G or 4G or Wi-Fi system. The wireless mobile communication system 203 may be configured to communicate with the Internet 209 through a gateway 205.

The Internet-based data storage module 213 may be configured to allow a user of the wireless mobile communication device 201 and/or others to read from and/or write to the diary 215, the diary options 217, the contacts database 219, and/or the calendar 221. The Internet-based data storage module 213 may be configured to do so when the user and/or others are using the wireless mobile communication device 201, a desktop computer 207, a desktop computer 211, or another type of device. The Internet-based data storage module 213 may be configured to authenticate the wireless mobile communication device 201, the desktop computer 207, and/or the desktop computer 211 before authorizing any access to the diary 215, the diary options 217, the contacts database 219, and/or the calendar 221.

The Internet-based data storage module 213 may be configured to provide different kinds of access to the diary 215, the diary options 217, the contacts database 219, and the calendar 221, depending upon the authentication information that is provided. For example, the Internet-based data storage module 213 may allow the primary user of the wireless mobile communication device 201 to both read from and write to the diary 215, the diary options 217, the contacts database 219, and/or the calendar 221. On the other hand, the Internet-based data storage module 213 may only grant persons other than the primary user of the wireless mobile communication device 201 read-only access to portions of the diary 215, such as portions of the diary 215 that relate to such persons. The Internet-based data storage module 213 may be configured to allow the primary user of the wireless mobile communication device 201 to regulate the type of access that is granted to such other persons.

The diary application that is contained within the wireless mobile communication device 201 may be installed prior to delivery of the wireless mobile communication device 201 to a user or may be downloaded and installed by the user after acquiring the wireless mobile communication device 201. In either case, the diary application 125 may be configured to allow a user to specify various options when installing, first running this application and/or later.

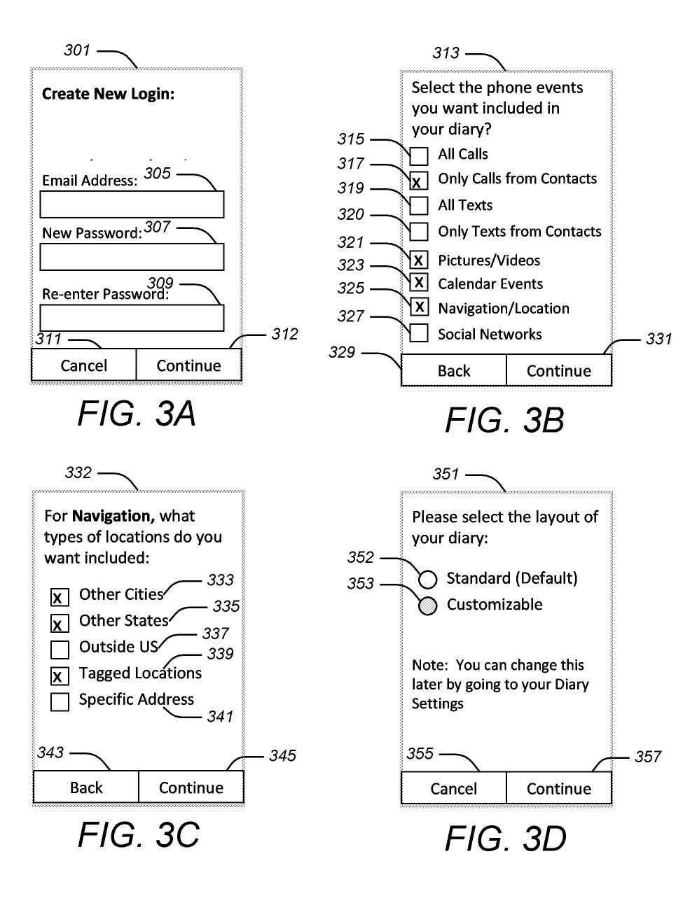

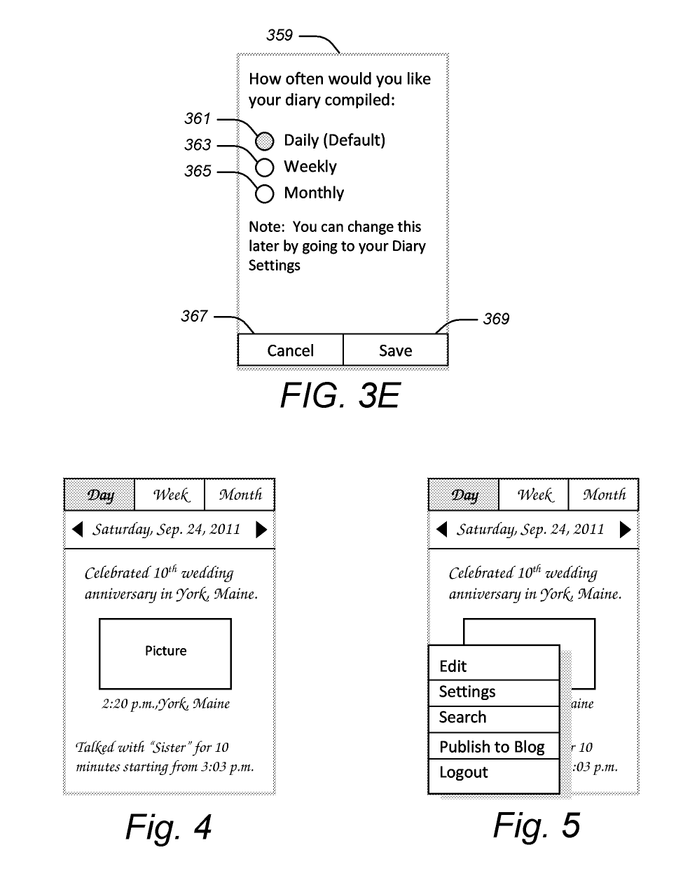

FIGS. 3A-3E illustrate an example of a series of dialogue boxes that may be displayed on the wireless mobile communication device 201 when setting up a diary application that logs events related to the wireless mobile communication device 201 into the Internet-based diary 215. Similar dialogue boxes may be provided when setting up a diary application that logs events related to the wireless mobile communication device 101.

FIG. 3A illustrates an example of a login setup dialog box 301 for setting up a login into the Internet-based data storage module 213. As illustrated in FIG. 3A, the login setup dialog box 301 includes an Email Address field 305 that is configured to receive an e-mail address, a New Password field 307 that is configured to receive a password, and a Re-enter Password field 309 that is configured to receive a replica of the same password. Using the login setup dialog box 301, a user may therefore specify information that authenticates the user to the Internet-based data storage module 213. A replica of this information may be stored in the Internet-based data storage module 213, thereby providing a means for the Internet-based data storage module 213 to authenticate the user each time the user seeks to open a communication channel with the Internet-based data storage module 213 (e.g., by logging into a predetermined diary-related website). The user may click a “Continue” button 312 after entering this login information to continue to the next screen, or click a “Cancel” button 311 to instead cancel data entry.

FIG. 3B illustrates an example of an event-setting dialog box 313 for indicating types of events that are to be tracked in the diary 215. As illustrated in FIG. 3B, the user may specify that all phone calls are to be tracked by selecting an “All Calls” box 315 or only phone calls from persons listed in the contacts database 219 by selecting an “Only Calls from Contacts” box 317. Similarly, the user may specify that all text messages are to be tracked by selecting an “All Text” box 319 or only text messages from persons listed in the contacts database 219 by selecting “Only Text from Contacts” box 320. The user may in addition or instead track all pictures and videos that are taken by selecting a “PicturesNideos” box 321; all calendar events by selecting a “Calendar Events” box 323, changes in location by selecting a “Navigation/Location” box 325, and/or social network postings by selecting a “Social Networks” box 327. The event-setting dialog box 313 may offer additional events for tracking, such as instant messages, e-mails, the use of all or selected software applications, the listening to music, the viewing of material such as on YouTube™, and/or may not offer all of the events that are illustrated in FIG. 3B.

After selecting all desired events for tracking, the user may click a “Continue” button 331 to continue with the next screen or a “Back” button 329 to return to the previous screen.

The selection of some events in the event-setting dialog box 313, in turn, may cause other dialogue boxes to appear. Each of these other dialogue boxes may solicit one or more refinements to a selected event.

FIG. 3C illustrates an example of a location-setting dialog box 332 for indicating locations that are to be entered into the diary 215 when the wireless mobile communication device 203 is present at the locations. The location-setting dialog box 332 specifies refinements to the “Navigation/Location” event that was selected in the event-setting dialog box 313. Specifically, the location-setting dialog box 332 allows the user to specify that the locations to be tracked should include other cities by selecting an “Other Cities” box 333, other states by selecting an “Other States” box 335, and/or locations outside of the United States by selecting an “Outside the US” box 337. The selection of any or all of these boxes may inherently mean that the user's return to a base location, such as to the user's home or office, will not be tracked with automatic diary entries. The return of the user to the base location may be offered as an additional tracking option.

A user may also elect to have tagged locations tracked by selecting a “Tagged Locations” box 339. When this box is checked, locations that are specified as tags to images captured by the camera module 107 may be tracked, as well as locations that have been specified as tags in connection with other applications, such as mapping, navigation, and/or social networking applications.

A user may also elect to have specific locations tracked by selecting a “Specific Address” box 341. Such a selection may be followed by another dialog box (not shown) in which the user may enter one or more specific addresses. The specific addresses and/or tagged locations may include the person's home, work, gym, family member's home, friend's home, and/or other locations. An option for the user to indicate the relevance of these locations (e.g., “home”, “Jim's house”) may be provided in a further screen (not shown).

A user may in addition or instead be permitted to specify that all changes in location that exceed a specified distance are to be tracked. The user may be permitted to include an amount of time that the wireless mobile communication device is to remain in the vicinity of each new location before it is tracked by an automated diary entry. This may prevent entries in the diary of locations through which the user is merely traveling.

After selecting all desired locations for tracking, the user may click a “Continue” button 345 to continue with the next screen or a “Back” button 343 to return to the previous screen.

The selection of other types of events in FIG. 3B may cause other dialogue boxes to be displayed. For example, the selection of the “Calendar Events” box 323 may cause a dialog box to open that asked the user whether an effort should be made to determine whether the calendared event has actually taken place before tracking it in the diary. For example, if the calendared event is a phone conference with a particular person, the data processing module 109 may be configured not to enter this calendared event until this phone conference has been detected to have taken place, such as, for example, by detecting whether a call has been connected with a phone number that is associated with the particular person in the contacts database 219. Similarly, if the calendar event is a performance at a particular venue, the data processing module 109 may be configured not to enter this calendared event until attendance at this event is detected, such as, for example, by detecting that the wireless mobile communication device 201 has been moved to the location of the venue. Similarly, if the “Social Networks” event is selected, a dialog box may open asking the user to identify the social networks that are to be tracked and, in some cases, the types of postings and other event information that is to be tracked.

FIG. 3D illustrates an example of a layout dialog box 351 for indicating the layout of the diary 215. As illustrated in FIG. 3D, a user may select a standard (Default) layout 352 or a Customizable layout 353. After selecting the layout, the user may click a “Continue” button 357 to continue to the next screen or a “Cancel” button 355 to cancel the setup. The default layout, for example, may list each event in the form of a sentence and may be sorted by date.

If the user selects the Customizable layout 353, a further dialog box may appear seeking information about how the user would like to customize the layout of a display of the diary 215.

FIG. 3E is an example of a time period dialog box 359 for specifying when the diary is to be compiled 123. As illustrated in FIG. 3E, the user may cause the diary to be compiled daily by selecting Daily (Default) 361, weekly by selecting Weekly 363, or monthly by selecting Monthly 365. The user may then click “Save” button 369 to save all of the setup selections that have been made or a “Cancel” button 367 to cancel the setup process.

Other layout options may be specified in addition or instead. For example, the user may be able to specify whether each event is recorded in the diary 215 in the form of a table and/or a grammatical phrase or sentence. The information about each event may be pulled from the module that was involved with the event and may be expressed in any format, including a multimedia format where only events with a corresponding multimedia file (e.g., image, audio file, video) are recorded, a location-based format, and/or a contact-based format

FIG. 4 illustrates an example of a page in the diary 215 being displayed. In this example, diary entries are made in the form of grammatical sentences or phrases, rather than a table. As also illustrated in FIG. 4, entries may be arranged in chronological order. A picture that was taken while at the location of the first event (a wedding in this example) may also be embedded. If “Pictures/Videos” 321 was selected when specifying the events to be tracked in FIG. 3B, such a picture would be entered automatically.

FIG. 5 illustrates an example of a menu of options that can be displayed when using the diary application. As illustrated in FIG. 5, such a menu may include entries such as “Edit” to allow editing of entries in the calendar, “Settings” to allow changes to the setup settings, “Search” to allow a search to be made through the entries in the diary 215, “Published to Blog” to allow a user to select all or portions of the diary 123 for publication to a blog, and/or “Logout” to close the display of the diary 123.

Unless otherwise indicated, the wireless mobile communication devices 101 and 201, the wireless mobile communication system 203, the desktop computers 207 and 211, and the Internet-based data storage module 213 are implemented with a computer system configured to perform the functions that have been described herein for the component. Each computer system includes one or more processors, memory devices (e.g., random access memories (RAMs), read-only memories (ROMs), and/or programmable read only memories (PROMS)), tangible storage devices (e.g., hard disk drives, CD/DVD drives, and/or flash memories), system buses, video processing components, network communication components, input/output ports, and/or user interface devices (e.g., keyboards, pointing devices, displays, microphones, sound reproduction systems, and/or touch screens).

Each computer system for the wireless mobile communication system 203 and the Internet-based data storage module 213 may include one or more computers at the same or different locations. When at different locations, the computers may be configured to communicate with one another through a wired and/or wireless network communication system.

Each computer system may include software (e.g., one or more operating systems, device drivers, application programs, and/or communication programs). When software is included, the software includes programming instructions and may include associated data and libraries. When included, the programming instructions are configured to implement one or more algorithms that implement one more of the functions of the computer system, as recited herein. Each function that is performed by an algorithm also constitutes a description of the algorithm. The software may be stored on one or more non-transitory, tangible storage devices, such as one or more hard disk drives, CDs, DVDs, and/or flash memories. The software may be in source code and/or object code format. Associated data may be stored in any type of volatile and/or non-volatile memory.

The components, steps, features, objects, benefits and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, objects, benefits and advantages. These also include embodiments in which the components and/or steps are arranged and/or ordered differently.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

All articles, patents, patent applications, and other publications that have been cited in this disclosure are incorporated herein by reference.

The phrase “means for” when used in a claim is intended to and should be interpreted to embrace the corresponding structures and materials that have been described and their equivalents. Similarly, the phrase “step for” when used in a claim is intended to and should be interpreted to embrace the corresponding acts that have been described and their equivalents. The absence of these phrases in a claim mean that the claim is not intended to and should not be interpreted to be limited to any of the corresponding structures, materials, or acts or to their equivalents.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

The terms and expressions used herein have the ordinary meaning accorded to such terms and expressions in their respective areas, except where specific meanings have been set forth. Relational terms such as first and second and the like may be used solely to distinguish one entity or action from another, without necessarily requiring or implying any actual relationship or order between them. The terms “comprises,” “comprising,” and any other variation thereof when used in connection with a list of elements in the specification or claims are intended to indicate that the list is not exclusive and that other elements may be included. Similarly, an element preceded by “a” or “an” does not, without further constraints, preclude the existence of additional elements of the identical type.

The Abstract is provided to help the reader quickly ascertain the nature of the technical disclosure. It is submitted with the understanding that it will not be used to interpret or limit the scope or meaning of the claims. In addition, various features in the foregoing Detailed Description are grouped together in various embodiments to streamline the disclosure. This method of disclosure is not to be interpreted as requiring that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as separately claimed subject matter.

The invention claimed is:

1. A wireless mobile communication device comprising:
a wireless mobile communication module configured to wirelessly communicate with a wireless mobile communication system;
a location detection module configured to detect the location of the wireless mobile communication device; and
a data processing module configured to automatically cause location information indicative of locations at which the wireless mobile communication device is present to be entered into a diary in association with date information indicative of when the wireless mobile communication device was present at each location.

2. The wireless mobile communication device of claim 1 wherein the data processing module is configured to:
receive location setting information from a user of the wireless mobile communication device that includes information indicative of individual locations that are to be entered into the diary when the wireless mobile communication device is present at the individual locations;
cause the location-setting information to be stored in a data storage module; and
automatically cause the location information in association with the date information to be entered into the diary when the wireless mobile communication device is at an individual location indicated by the location setting information.

3. The wireless mobile communication device of claim 2 wherein the location-setting information is indicative of one or more locations that are excluded from being automatically entered into the diary when the wireless mobile communication device is present at the locations.

4. The wireless mobile communication device of claim 1 wherein the data processing module is configured to cause new location information to be entered into the diary each time the wireless mobile communication device travels a pre-determined distance from the last location at which location information was entered into the diary.

5. The wireless mobile communication device of claim 4 wherein the data processing module is configured to cause new location information to be entered into the diary only when the wireless mobile communication device remains in the vicinity of the new location for a pre-determined period of time.

6. The wireless mobile communication device of claim 1 wherein the data processing module is configured to automatically cause the location information to be entered into the diary in association with events that relate to the wireless mobile communication device, other than changes in its location, along with descriptive information that is descriptive of each event.

7. The wireless mobile communication device of claim 6 wherein the data processing module is configured to:
receive event-setting information from a user of the wireless mobile communication device indicating types of events that are to be tracked in the diary;
cause the event-setting information to be stored in a data storage module; and
automatically cause the location information in association with the date information to be entered into the diary when an event is of a type indicated by the event-setting information.

8. The wireless mobile communication device of claim 6 wherein the events include communications between the wireless mobile communication device and other devices.

9. The wireless mobile communication device of claim 8 wherein the data processing module is configured to:
receive communication-setting information from a user of the wireless mobile communication device indicating types of communications that are to be tracked in the diary;
cause the communication-setting information to be stored in a data storage module; and
automatically cause the location information in association with the date information and the descriptive information to be entered into the diary in connection with each communication of a type indicated in the communication-setting information.

10. The wireless mobile communication device of claim 9 wherein the data processing module is configured to receive communication-setting information that indicates that only communications with persons in a contacts database are to be tracked in the diary.

11. The wireless mobile communication device of claim 6 wherein the events include events that are in a calendar.

12. The wireless mobile communication device of claim 11 wherein the data processing module is configured to:
determine whether each calendared event has taken place; and
automatically cause the location information in association with the date information and the descriptive information to be entered into the calendar only after determining that the calendared event has taken place.

13. The wireless mobile communication device of claim 6 wherein:
the wireless mobile communication device includes a camera module configured to capture one or more images in the vicinity of the wireless mobile communication device; and
the events include the capture of one or more images by the camera module.

14. The wireless mobile communication device of claim 13 wherein the descriptive information includes at least one image associated with each image capture event.

15. The wireless mobile communication device of claim 6 wherein the data processing module is configured to cause information indicative of the length of the events to be entered into the diary.

16. The wireless mobile communication device of claim 1 wherein the data processing module is configured to receive a search query from a user and to filter the entries in the diary based on the search query.

17. The wireless mobile communication device of claim 16 wherein the data processing module is configured to receive a search query from a user that includes an identification of a person.

18. A wireless mobile communication device comprising:
a wireless mobile communication module configured to wirelessly communicate with a wireless mobile communication system;
a phone call module configured to allow a user of the wireless mobile communication device to participate in wireless phone calls using the wireless mobile communication module; and
a data processing module configured to automatically cause phone call information indicative of phone calls with the wireless mobile communication device to be entered into a diary in association with date information indicative of when each of the phone calls took place and person information indicative of who participated in the phone call with the wireless mobile communication device.

19. The wireless mobile communication device of claim 18:
further comprising a location detection module configured to detect the location of the wireless mobile communication device; and
wherein the data processing module is configured to automatically cause location information indicative of locations at which the wireless mobile communication device is having the phone calls to be entered into the diary in association with the phone call and person information.

20. A wireless mobile communication device comprising:
a wireless mobile communication module configured to wirelessly communicate with a wireless mobile communication system;
a text messaging module configured to allow a user of the wireless mobile communication device to send and receive text messages using the wireless mobile communication module; and
a data processing module configured to automatically cause text messaging information indicative of text messages with the wireless mobile communication device to be entered into a diary in association with date information indicative of when the text messages took place and person information indicative of who participated in the text messages with the wireless mobile communication device.

21. The wireless mobile communication device of claim 20:
further comprising a location detection module configured to detect the location of the wireless mobile communication device; and
wherein the data processing module is configured to automatically cause location information indicative of locations at which the wireless mobile communication device is communicating text messages to be entered into the diary in association with the text messaging and person information.
